(19) United States
(12) Patent Application Publication
(10) Pub. No.: US 2005/0138217 A1
(43) Pub. Date: Jun. 23, 2005

(54) Bus interface for optical transceiver devices

(76) Inventors: Stefano G. Therisod, Sunnyvale, CA (US); Myunghee Lee, San Jose, CA (US); Takashi Hidai, Palo Alto, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/732,936

(22) Filed: Dec. 10, 2003

(51) Int. Cl. G06F 3/00

(52) U.S. Cl. 710/1

(57) ABSTRACT

A communications system includes a transceiver and a host board. The transceiver includes an interrupt request terminal and a communication port. The host board includes an interrupt request line and a communication bus, wherein the interrupt request line is coupled to the interrupt request terminal to receive an interrupt request, and the communication bus is coupled to the communication port to receive data.

### FIELD OF INVENTION

This invention relates to the communication between transceiver modules and a host board.

### DESCRIPTION OF RELATED ART

With the increasing complexity of the fiber optics transceiver modules, the amount of information that needs to be stored and transferred between these modules and a host board is increasing considerably. For this reason, conventional transceiver modules have been designed with an interface (e.g., a two wire serial interface such as the I2C bus), as illustrated in FIG. 1, that allows the host board to communicate with the transceiver modules. For example, transceiver modules can be small form-factor pluggable (SFP) and small form-factor (SFF) optical or copper transceiver modules.

The drawback of this architecture is the need for the host board to continuously poll the transceiver modules connected to the bus in order to verify their status. With the increasing complexity of the host board, the number of transceiver modules connected to the same bus may reach a limit where the latency time, due to the continuous polling of the ever-increasing number of transceiver modules, may be too high to guarantee the correct functioning of the host system.

Thus, what is needed is a communications system that addresses the potential latency problem in a conventional system.

### SUMMARY

In one embodiment of the invention, a communications system includes a transceiver and a host board. The transceiver includes an interrupt request terminal and a communication port. The host board includes an interrupt request line and a communication bus, wherein the interrupt request line is coupled to the interrupt request terminal to communicate an interrupt request, and the communication bus is coupled to the communication port to communicate data.

### BRIEF DESCRIPTION OF THE DRAWINGS

FIG. 1 is a block diagram of a conventional fiber optics system.

FIG. 2 is a block diagram of a communications system in one embodiment of the invention.

FIG. 3 is a block diagram of an event detector that sends an interrupt request in one embodiment of the invention.

FIG. 4 is a flowchart of the communication between transceiver modules and a host board in one embodiment of the invention.

FIG. 5 is a block diagram of a communications system in another embodiment of the invention.

FIG. 6 is a block diagram of a communications system in another embodiment of the invention.

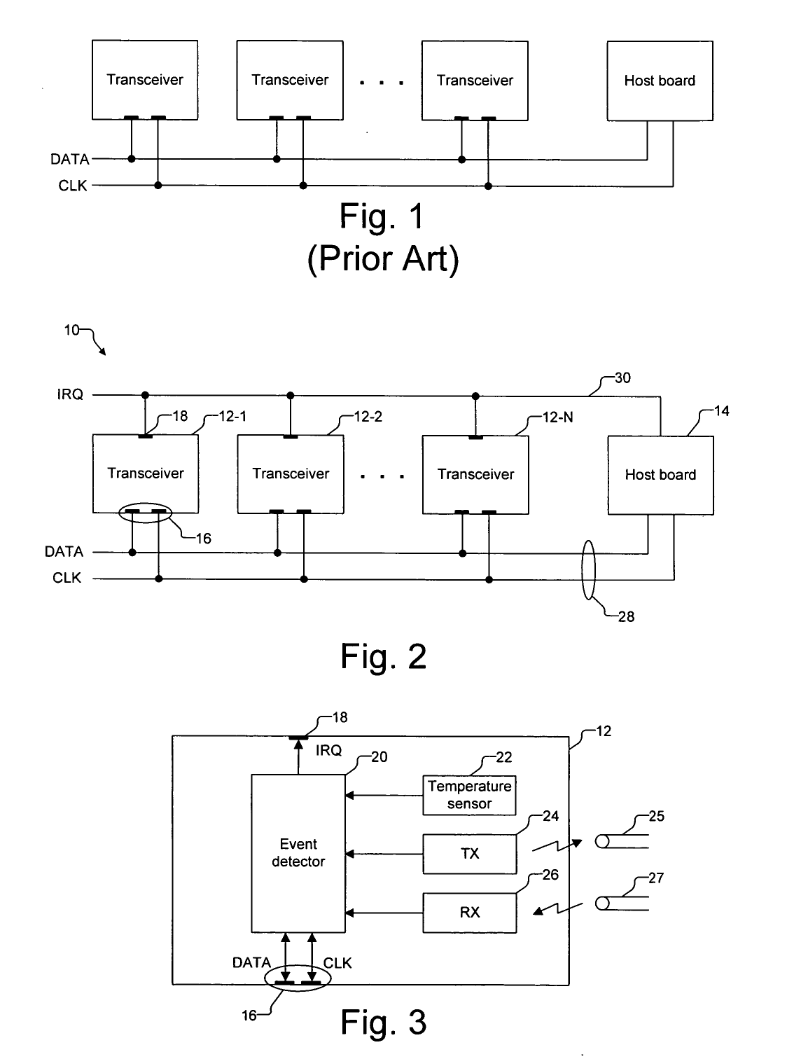

### DETAILED DESCRIPTION

FIG. 2 is a block diagram of a communications system 10 in one embodiment of the invention. System 10 includes multiple transceiver modules 12-1, 12-2 . . . 12-N (where N is a variable) and a host board 14. A transceiver module is any device designed to send and/or receive optical and/or electrical signals. A host board is any system board that uses the transceiver modules to implement a communications system. In one embodiment, transceiver modules 12-1 to 12-N and host board 14 conform to the SFP specification. Transceiver modules 12-1 to 12-N each has a communication port 16 for communicating with host board 14. Furthermore, transceiver modules 12-1 to 12-N each has an interrupt request terminal 18 for signaling to host board 14 that an event has occurred. For clarity, only one port 16 and one terminal 18 have been labeled.

Transceiver modules 12-1 to 12-N can each be implemented as a transceiver module 12 shown in FIG. 3. In one embodiment, transceiver module 12 includes an event detector 20 that is coupled to detect various conditions and events. For example, event detector 20 is coupled to a temperature sensor 22 to monitor the temperature of transceiver module 12. Event detector 20 is coupled to optoelectronic transmitter 24 to monitor the current to the laser. Optoelectronic transmitter 24 emits light that carries data to a fiber 25. Event detector 20 is coupled to an optoelectronic receiver 26 to detect a loss of signal (LOS), a loss of lock, and a parity error. Optoelectronic receiver 26 detects light that carries data in from a fiber 27.

In response to a condition exceeding a predetermined threshold or when an event occurs, event detector 20 would signal an interrupt request via terminal 18 to host board 14. In one embodiment, terminal 18 is an open-collector connection so that multiple transceiver modules can be connected to one interrupt request line. When polled by host board 14, event detector 20 would signal the condition or event that caused the interrupt request, along with associated information of the condition or event, via port 16 to host board 14. In one embodiment, port 16 is an open-collector connection so that multiple transceiver modules can be connected to one bus.

One skilled in the art understands that event detector 20 can be implemented in a variety of ways, including using an application-specific integrated circuit (ASIC), a processor, a programmable logic, or a combination thereof. Event detector 20 can generate the IRQ signal as pulses or a continuous signal. The IRQ signal can be automatically cleared or cleared on reading the status byte, either by hardware or software. The IRQ detection circuit in host board 14 can be edge sensitive or level sensitive. Furthermore, host board 14 can include a buffer to store the IRQ status. Of course, transceiver module 12 and host board 14 can include additional circuitry and components.

Referring back to FIG. 2, host board 14 includes a communication bus 28 for communicating with transceiver modules 12-1 to 12-N. Communication bus 28 can conform to any standard. In one embodiment, communication bus 28 is a two-wire serial interface having a data line DATA and a clock line CLK. Host board 14 further includes an interrupt request line 30 for receiving interrupt requests from transceiver modules 12-1, 12-2 . . . 12-N. Unlike a conventional host board that periodically polls the individual transceiver modules, host board 14 only polls transceiver modules 12-1 to 12-N after receiving an interrupt request. Host board 14 polls transceiver module 12-1 to 12-N over communication bus 28 to determine which transceiver module signaled the interrupt request. After determining which transceiver module signaled the interrupt request, host board 14 polls the requesting transceiver module over communication bus 28 for the condition or the event that caused the interrupt request.

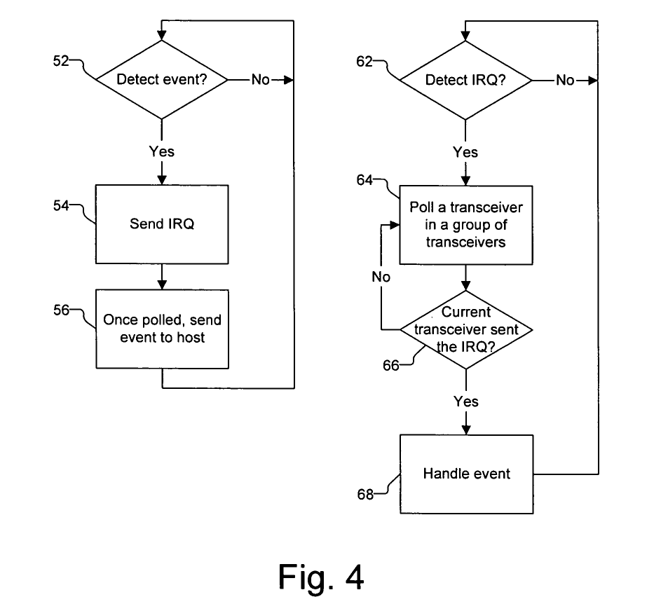

FIG. 4 is a flowchart for transceiver modules and a host board (e.g., transceiver modules 12-1 to 12-N and host board 14) to communicate in one embodiment. The steps implemented by each transceiver modules are explained in steps 52, 54, and 56, while the steps implemented by the host board are explained in steps 62, 64, 66, and 68.

In step 52, transceiver module 12 monitors one or more conditions/events. If a condition exceeds a predetermined threshold or if an event occurs, then step 52 is followed by step 54. Otherwise step 52 loops and transceiver module 12 continues to monitor one or more conditions/events.

In step 54, transceiver module 12 signals an interrupt request via terminal 18 to host board 14. Step 54 is followed by step 56.

In step 56, transceiver module 12 is polled by host board 14 via port 16. In response, transceiver module 12 signals the condition or event and its associated information that caused the interrupt request to host board 14 via port 16. Step 56 is followed by step 52 and the process described above repeats.

In step 62, host board 14 monitors for an interrupt request via line 30 from any of transceiver modules 12-1 to 12-N. If host board 14 receives an interrupt request, then step 62 is followed by step 64. Otherwise step 62 loops and host board 14 continues to monitor for an interrupt request.

In step 64, host board 14 polls via bus 28 a transceiver module from the transceiver modules that share one interrupt request line. Step 64 is followed by step 66.

In step 66, host board 14 determines if the polled transceiver module is the transceiver module that signaled the interrupt request. If so, step 66 is followed by step 68. Otherwise step 66 is followed by step 64 and host board 14 continues to polls the next transceiver module from the transceiver modules that share one interrupt request line.

In step 68, host board 14 polls and then handles the condition or event and its associated information from the requesting transceiver module via bus 28. Step 68 is followed by step 62 and the process described above repeats.

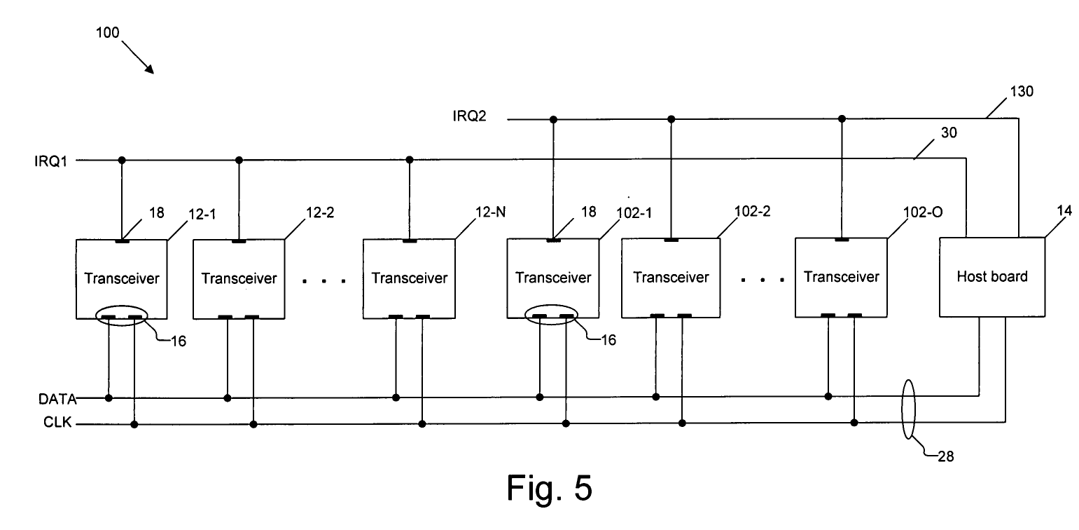

FIG. 5 is a block diagram of a communications system 100 in another embodiment of the invention. System 100 is similar to system 10 except that the transceiver modules are divided into groups and the transceiver modules in each group share one interrupt request line to host board 14. For example, transceiver modules 12-1 to 12-N share interrupt request line 30 to host board 14, and transceiver modules 102-1, 102-2 . . . 102-0 (where O is a variable) share an interrupt request line 130 to host board 14. Furthermore, transceiver modules 12-1 to 12-N and 102-1 to 102-0 all share communication bus 28 to host board 14. In this embodiment, host board 14 is preprogrammed to know which group is associated with which interrupt request line. Thus, if host board 14 receives an interrupt request on line 130, host board 14 would know to poll via bus 28 the group consisting of transceiver modules 102-1 to 102-0 to determine the requesting transceiver module and the condition or event that caused the interrupt request.

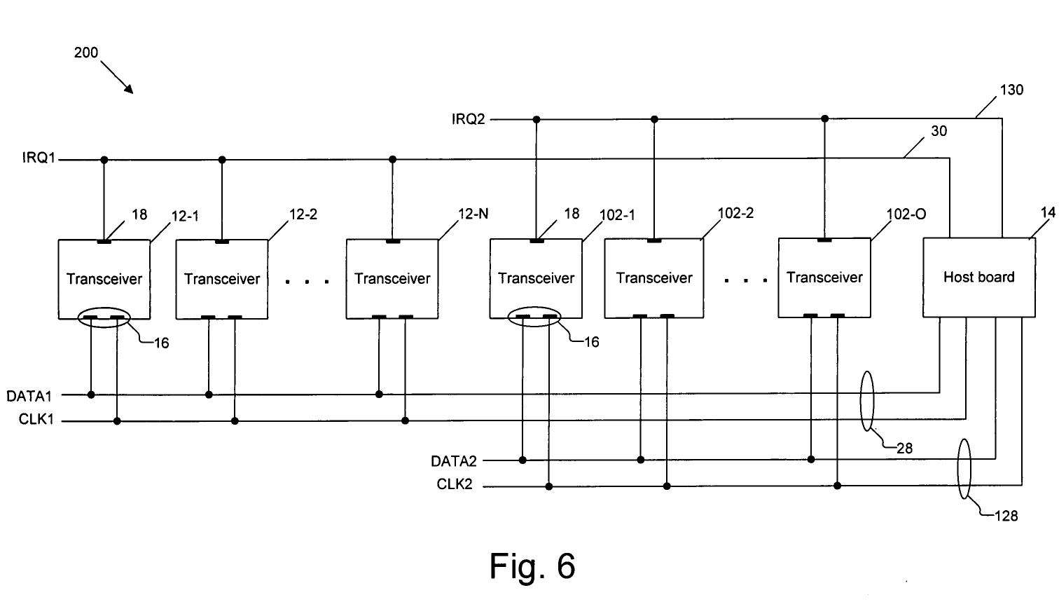

FIG. 6 is a block diagram of a communications system 200 in one embodiment of the invention. System 200 is similar to system 100 except that each group of transceiver modules shares one communication bus to host board 14. For example, transceiver modules 12-1 to 12-N share communication bus 28 to host board 14, and transceiver modules 102-1 to 102-O share communication bus 128 to host board 14. In this embodiment, host board 14 is preprogrammed to know which group is associated with which interrupt request line and which communication bus. Thus, if host board 14 receives an interrupt request on line 130, host board 14 would know to poll via bus 128 the group consisting of transceiver modules 102-1 to 102-0 to determine the requesting transceiver module and the condition or event that caused the interrupt request.

Various other adaptations and combinations of features of the embodiments disclosed are within the scope of the invention. Numerous embodiments are encompassed by the following claims.

1. A communications system, comprising:
a transceiver, comprising:
an interrupt request terminal; and
a communication port;
a host board, comprising:
an interrupt request line;
a communication bus;
wherein the interrupt request line is coupled to the interrupt request terminal to communicate an interrupt request, and the communication bus is coupled to the communication port to communicate data.

2. The system of claim 1, wherein the transceiver is selected from the group consisting of an optical transceiver and a copper transceiver.

3. The system of claim 1, further comprising:
another transceiver, comprising:
another interrupt request terminal; and
another communication port;
wherein the interrupt request line is further coupled to said another interrupt request terminal to communicate another interrupt request, and the communication bus is further coupled to said another communication port to communicate other data.

4. The system of claim 1, further comprising:
another transceiver, comprising:
another interrupt request terminal; and
another communication port;
wherein the host board further comprises another interrupt request line, said another interrupt request line being coupled to said another interrupt request terminal to communicate another interrupt request, and the communication bus being further coupled to said another communication port to communicate other data.

5. The system of claim 1, further comprising:
another transceiver, comprising:
another interrupt request terminal; and
another communication port;
wherein the host board further comprises another interrupt request line and another communication bus, said another interrupt request line being coupled to said another interrupt request terminal to communicate another interrupt request, and said another communication bus being coupled to said another communication port to communicate other data.

6. A communications system, comprising:
a plurality of first transceivers each comprising an interrupt request terminal and a communication port;
a host board comprising an interrupt request line and a communication bus;
wherein the interrupt request line is coupled to the interrupt request terminal of each first transceiver to communicate an interrupt request, and the communication bus is coupled to the communication port of each first transceiver to communicate data.

7. The system of claim 6, wherein the first transceivers are selected from the group consisting of optical transceivers and copper transceivers.

8. The system of claim 6, further comprising:
a plurality of second transceivers each comprising another interrupt request terminal and another communication port;
wherein the host board further comprises another interrupt request line, said another interrupt request line being coupled to said another interrupt request terminal of each second transceiver to communicate another interrupt request, and the communication bus being coupled to said another communication port of each second transceiver to communicate other data.

9. The system of claim 6, further comprising:
a plurality of second transceivers each comprising another interrupt request terminal and another communication port;
wherein the host board further comprises another interrupt request line and another communication bus, said another interrupt request line being coupled to said another interrupt request terminal of each second transceiver to communicate another interrupt request, and the said another communication bus being coupled to said another communication port of each second transceiver to communicate other data.

10. A method for communicating between transceivers and a host board, comprising:
receiving an interrupt request from one of the transceivers;
polling said one of the transceivers in response to the interrupt request.

11. The method of claim 10, wherein the transceivers are selected from the group consisting of optical transceivers and copper transceivers.

12. The method of claim 10, wherein said polling said one of the transceivers comprising polling a group of the transceivers that share one interrupt request line to the host board.

13. The method of claim 11, further comprising handling an event that caused the interrupt request from said one of the transceivers.
